(19) United States
(12) Patent Application Publication
(10) Pub. No.: US 2015/0211644 A1
(43) Pub. Date: Jul. 30, 2015

(54) Adapter for Marine Ball and Related Valves

(71) Applicant: Seann Pavlik, Fort Lauderdale, FL (US)

(72) Inventor: Seann Pavlik, Fort Lauderdale, FL (US)

(21) Appl. No.: 14/549,076

(22) Filed: Nov. 20, 2014

Related U.S. Application Data
(63) Continuation-in-part of application No. 12/806,473, filed on Aug. 14, 2010, now abandoned.

(51) Int. Cl. F16K 5/06

(52) U.S. Cl. CPC F16K 5/0647

(57) ABSTRACT

In a valve for placement within a fluid conduit, the valve including a generally spherical element in fluid-tight relation to an interior diameter of the valve, a fluid flow existing through a bore of the spherical element integral handle projecting externally slightly past a slot and an outer housing of the valve. An extent of fluid flow through the valve bore changeable by rotation of the projecting handle and the spherical element. The adapter is defined by a solid body having a longitudinal axis, an inner axial base complemental with the projecting handle of the spherical element and, at an opposite base, an outer surface engagable by a complemental extension of a ratchet wrench. The ratchet wrench may effect a full or partial opening or closure of the valve by respective incremental reciprocations, either forwardly or backwardly, of the projecting handle of the spherical element.

### REFERENCE TO RELATED APPLICATION

This application is a continuation-in-part of application Ser. No. 12/806,473, filed Aug. 14, 2010, and the same is incorporated herein by reference in its entirety.

### FIELD OF THE INVENTION

The present invention relates to an adapter for various valves of types, commonly used in fluid flow applications in marine, fire control and related applications.

### BACKGROUND OF THE INVENTION

Ball, cock, plug and butterfly valves are characterized by use of a large sphere or cylinder within the path of flow of the valve. Such spheres are provided with a hole or port along the axis or middle thereof, so that when the port is aligned with the input and output of the valve, a full and unimpeded flow of fluid will occur. When such a sphere is rotated, the port therethrough is turned perpendicular to the walls of the valve thereby blocking the flow of fluid.

Turning or rotation of the internal sphere of the valve is accomplished through the provision of a handle or other element projecting integrally from said sphere through a diameter of the sphere and then externally through the walls of the valve so that it may be engaged by a special-purpose wrench having an aperture near to an end thereof in which the aperture is complemental in geometry to that of the integrally projecting element of the sphere of the valve. See FIG. 1. A limitation with such valves is that, in most applications, the special-purpose wrench is attached, typically by a nut or bolt, to the externally projecting element or handle by which the valve then may be opened or closed. The handles of such wenches in many applications, can be very long, whether integrally attached or not to the valve handle element, thereby, limiting the space or area within which one may work near to the ball valve. Further, in certain applications, as in the holds or bottom regions of large, yachts, boats, ships and the like, many dozens of such ball valves and their elongate handles may be present in a small space, a result of which is to render difficult and awkward work in areas or locations of such valves where it is necessary that other activities also occur. Further, the conventional handle elements employed with a ball valve is typically lacking in precision and, for the most part, is intended to accomplish a digital, that is, complete on or complete off function of the valve.

The present invention is therefore directed to an adapter for which an improvement in controls for ball valves, and the like, eliminates the requirement for a long, permanently or semi-permanently attached handle to the ball valve which compromises the utility of lower regions of boats in which several such valves are situated. It is further directed to achieving a common means for the opening or closing such valves throughout a vessel, industrial facility or the like.

It is also known in the art to provide the projecting handle of the sphere of a ball valve with a polygonal surface (see U.S. Pat. No. 4,634,098 to Varden) but that solution adds little to the standard rectangular surface of the projecting element 20, as shown in FIG. 1. Further, such a polygonal surface is specific to a single valve type and, as such, could not function as the broad spectrum adapter taught herein.

Other prior art, as known to the inventor, consists of U.S. Pat. No. 4,467,823 to Shaffer, which does not teach an adapter selectably attachable to a ball valve handle or usable with a ratchet wrench, which his generally less convenient than the solution set forth herein.

The present invention thus addresses the above needs in the art by provision of an adapter that permits flow through said port of said spherical element to be incrementally changed or closed without need for a permanently attached and special purpose handle of unsuitable length.

### SUMMARY OF THE INVENTION

The invention relates to an adapter for opening or rotation of a ball valve or the like. The valve include a generally spherical element in fluid-tight relation to an interior diameter of said valve, and having a fluid flow through a bore of said element, the element having an integral projecting handle extending externally slightly past a slot in an outer housing of said valve, a degree of fluid flow through said fluid flow port changeable by rotation of said integral handle and its integral spherical element. An inner axial surface of the adapter defines a female recess engagable by said valve handle. An outer axial surface of the adapter defines a male protrusion engagable by a ratchet wrench. Therein, said wrench may effect a full or partial rotation of said projecting handle and, thereby, the valve sphere, by the incremental reciprocation, either forwardly or backwardly, of the valve handle.

It is an object to provide an adaptor for engagement with an external handle of a ball valve or the like which may then be used with a ratchet wrench or the like to accomplish a selective full or partial opening or closing of said valve by the reciprocation, either forwardly or backwardly, of the handle of the ratchet wrench, this without need for any permanent attachment to the ratchet wrench or its handle to the external handle of the ball valve.

It is a further object to provide an adaptor of the above type which will avoid the clutter typically involved in engine rooms and the like in ships which require the continuous attachment of long wrench handles to the many such valves which are typically present within the hold or bottom of a ship or boat.

It is a yet further object of the invention to provide a means of whole or partial turn-on or turn-off of any valve of the quarter-turn of family valves inclusive of ball, butterfly, plug, and cock valves.

It is another object to provide an adaptor which permits full or partial turn-on or off of valves of the above nature without the requirement of a large amount of force applied to the lever of prior art wrenches and, thereby, to diminish the possibility of breakage of such handle that may occur after many years of non-use, as is typical in various applications.

It is a yet further object of the present invention to provide an external ratchet wrench adaptor for ball valves and the like which is reliable and precise in its degree of opening or closure of a ball valve.

The above and yet other objects and advantages of the present invention will become apparent from the hereinafter set forth Brief Description of the Drawings, Detailed Description of the Invention and Claims appended herewith.

### BRIEF DESCRIPTION OF THE DRAWINGS

FIG. 1 is a breakaway view showing a prior art ball valve and the special-purpose wrench associated therewith.

FIG. 2 is a front elevational view of the prior art ball valve or the like.

FIG. 3 is a perspective view of the prior art ball valve wrench.

FIG. 4 is a side elevational exploded view of the view of FIG. 1.

FIG. 5 is a perspective view of the present inventive adaptor.

FIG. 6 is an exploded view showing the manner of positioning of the inventive adaptor upon a ball valve or the like.

FIG. 7 is an assembly view of FIG. 6, however without showing the ratchet wrench used therewith.

FIG. 8 is an inner view of the adaptor of FIG. 5.

FIG. 9 is an outer view thereof.

FIG. 10 is a side elevational view of the adaptor shown in FIG. 5.

### DETAILED DESCRIPTION OF THE INVENTION

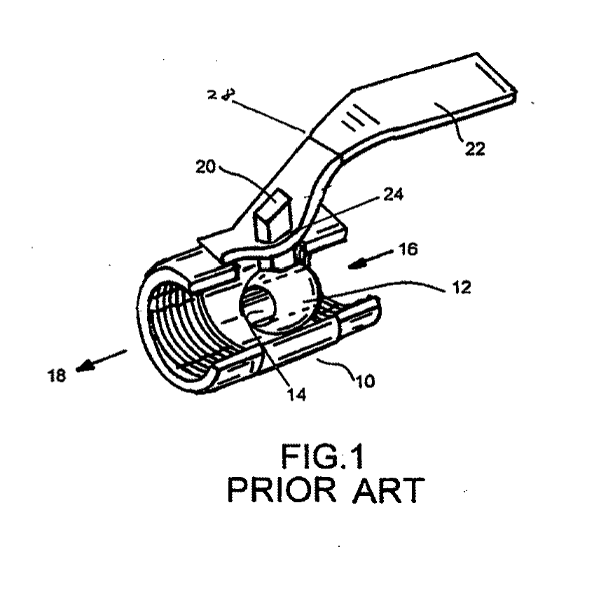

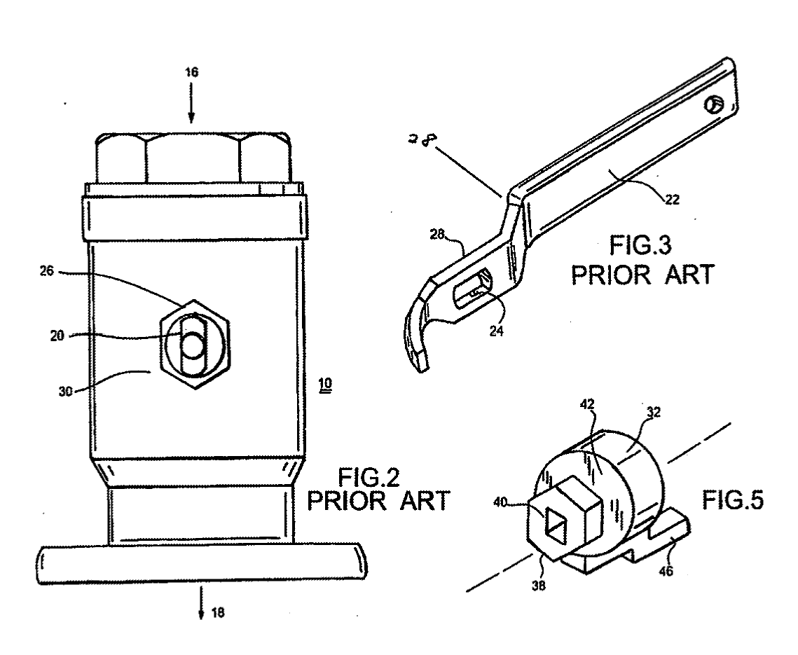

With reference to the breakaway view of FIG. 1, there is shown a prior art ball valve which, as may be noted therein, includes a valve proper 10 within which is a spherical element 12 through which includes a bore 14. As related in the Background of the Invention, normal fluid flow through the valve occurs when the axis of the port is in alignment with the axis of the respective input 16 and output 18 of the valve. Valves of this type are also characterized by in radially projecting handle 20 which is integral to spherical element 12 which, when rotated by a special purpose external wrench 22 alters the path of fluid flow through port 14 by up to 90 degrees in either the clockwise or counterclockwise direction. Such valves typically exhibit a rectangular cross-section. Valves of this family (which include butterfly, cock and plug valves) are often termed quarter-turn valves and are considered durable and particularly reliable to achieve an absolute shut-off or turn-on even after years of disuse, as such, representing an excellent choice where shutoff or turn-on is required (often in large volumes) in an emergency situation. However, to insure that the capability is always present to turn-on or off the flow of the valve, in the prior art it is necessary to employ said special purpose wrench 22, having an aperture 24 complemental in geometry to the cross-section of said handle 20 (see also FIGS. 2-4). Furthermore, because of the emergent nature of a turn-on or disablement of flow through such valve, when such a need arises, it is typical that such wrenches 22 are kept as a permanent or semi-permanent part of the assembly, as is shown in FIG. 1. Further, as noted in the Background and Summary of the Invention, such prior art wrenches are long and therefore often awkward to operate.

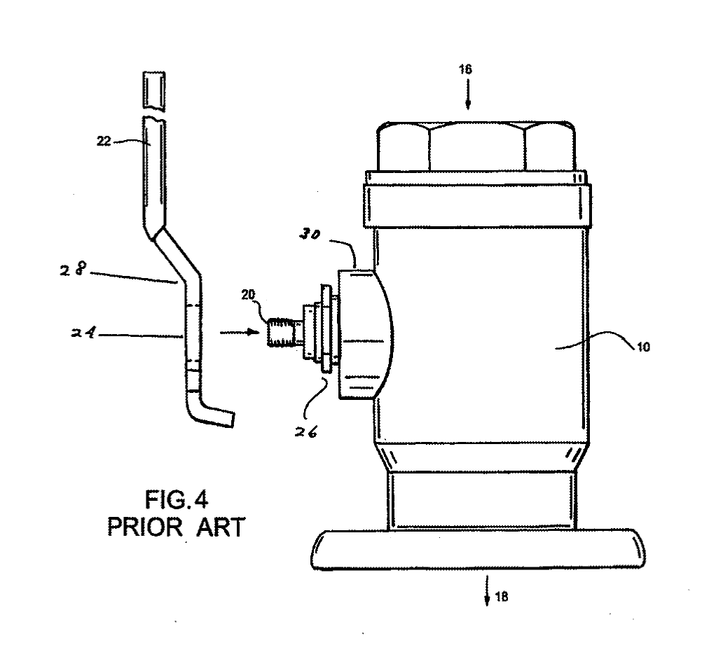

The above also may be appreciated with respect to the elevational view of FIG. 2 of the valve 10, and the perspective view of FIG. 3 of the wrench 22. Region 26 in FIG. 2 represents the normal circumference or periphery of the rotational edge 28 of wrench 22. However, the hexagonal region 30 shown in FIG. 2 represents another emergency means by which such valves may be shut-off in the event of breakage or failure of the handle 20 or wrench 22. An exploded view of the illustration of the prior art shown in FIG. 1 also appears in FIG. 4.

With reference to FIGS. 5 to 10, there is shown the present inventive wrench valve-to-adapter 32, the purpose of which is to facilitate the opening and closing of ball valves and the like without requirement for wrench 22 as above described and, more importantly, without requirement for a long element protruding far from the valve as is shown in FIGS. 1 and 4.

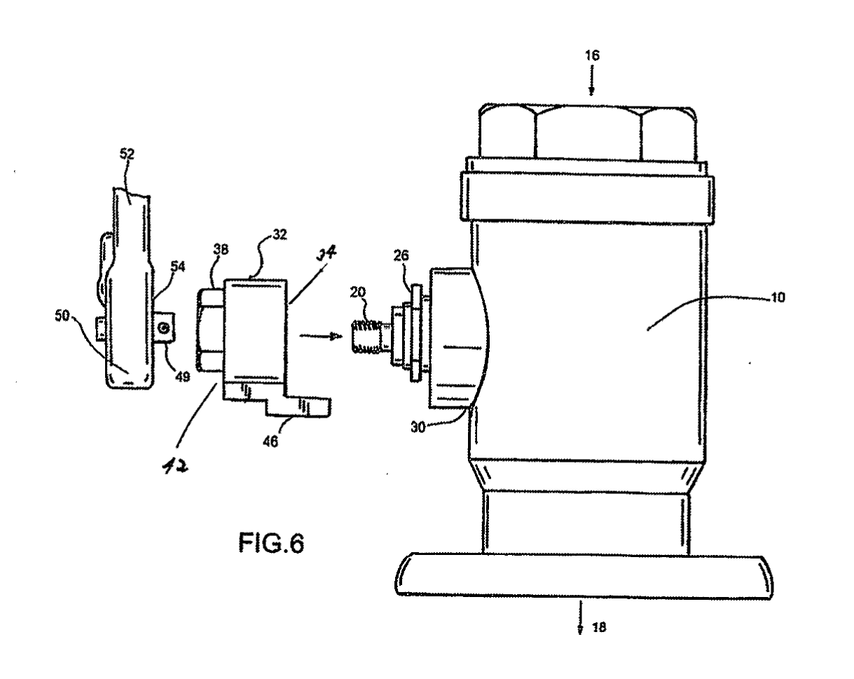

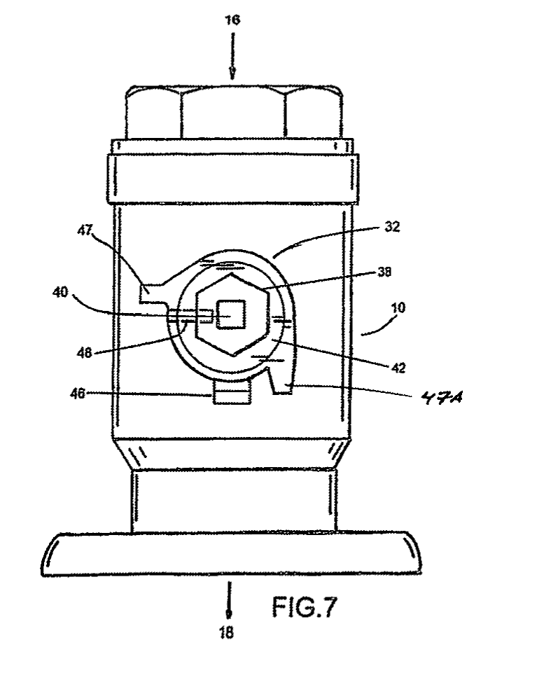

Adaptor 32 includes an inner surface 34 (FIGS. 6, 8 and 10) having therein an aperture 36 complemental to handle 20 of the traditional ball valve, as above described. At an outer surface 42 of adaptor 32 is provided a polygonal or hex-nut 38 that includes a female recess 40 (see FIGS. 7 and 9) within hex-nut 38 protruding from surface 42 of the adaptor. The present inventive adapter is optionally characterized by axial and radial extension elements 46, 47 and 47A which operate to stabilize the adapter relative to region 30 the body 10 of the valve proper (see FIGS. 6 and 7).

As may be noted in FIGS. 7, 8 and 10, an Allen head screw 48 is employed to ensure stability of the adapter 32 relative to handle 20 of the ball valve.

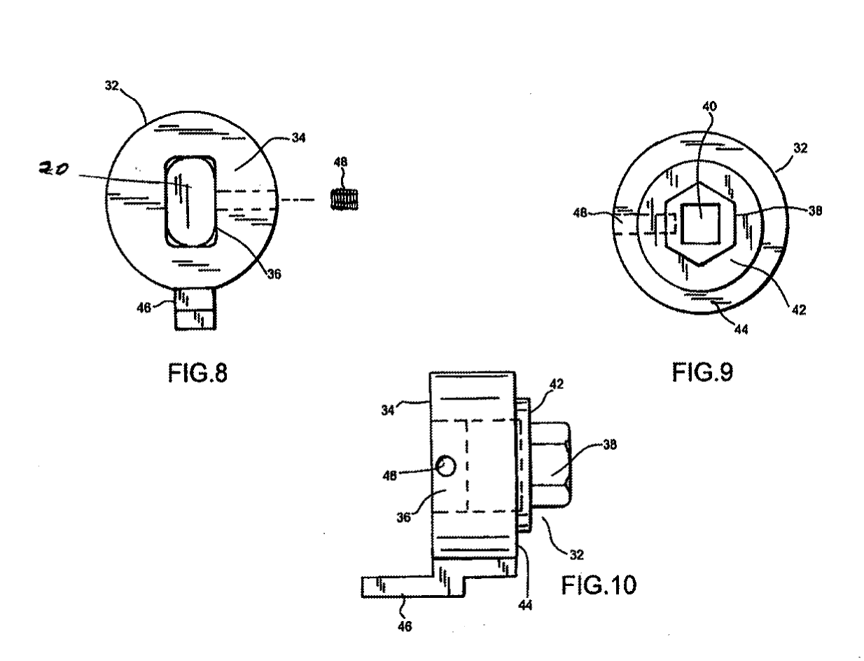

In the exploded view of FIG. 6 at the right thereof is shown the manner of placement of adapter 32 relative to the prior art shut-off assembly, as above described, inclusive of handle 20, rotational portion 26, and region 30. When adapter 32 is secured thereto (see FIGS. 8-9) through the use of recess 36 and Allen head screw 48, engagement surface 54 of ratchet wrench head 50 (see FIGS. 6 and 9) may be placed upon area 42 and about the hex-nut 38 of the adapter such that, using the lever effect of ratchet wrench handle 52, ratchet wrench 50 may be incrementally advanced, in the normal method of use thereof, to achieve incremental degrees of opening or closure of fluid flow through valve 10 by incremental rotation or counter-rotation of ratchet handle 52 and thereby of valve handle 20 which is integral to spherical element 12.

Thereby, the instant invention addresses not only the substantial clutter and compromise of otherwise usable space caused by the requirement of continuous attachment of ball wrench handle 22 to the ball valve handle 20 but, as well, each enables incremental (on the range of 10 degrees per reciprocation) advances of handle 20 of the ball valve. This renders it practical to accomplish a partial turn-on or turn-off of any valve in the quarter-turn family of valves which, as above noted, includes ball, butterfly, plug, and cock valves.

Another utility regarding such valves is that wrenches 22 of the prior art generally require a large amount of force to initiate rotation of handle 20, particularly if such a valve has not been opened or closed for many years. As such, handle 20 may break, particularly at area 28, when stressed after many years of non-use. As is well known, ratchet wrenches enable more force to be applied by its long lever arm and a wide radius and also are extremely reliable and precise wrenches, the utility of which has been established over years of historic use.

In the views of FIGS. 6 and 9, bottom inner surface 54 of the ratchet wrench is positioned within channel 40 complementally over hex head 38 of the adapter 32. However, in an alternative embodiment of the invention, a ratchet wrench having only a female recess may be employed which directly engages the peripheral exterior of hex structure 38 which, thereby, may also effect the incremental opening and closing of the ball valve without requirement for the locking of male element 49 of the ratchet wrench to female recess 40 of the adapter.

FIG. 7, which is an assembly view of the present invention, indicates that adapter 32 may be provided with a lower extension 46, also shown in FIGS. 7, 8 and 10, and radial extensions 47 and 47A. The utility of these extensions to provide an alternative means of opening or closure of the ball valve in the event of failure or unavailability of the ratchet wrench 50/52. It is to be appreciated that the present invention may be practiced with respect to any form of ratchet wrench whether or not provided with a hex male head 49 as long as a suitable engagement with female recess 40 of the adapter 32 can be accomplished. See FIGS. 6 and 8.

It is also to be appreciated that the adapter 22 may employ a wholly male element, in lieu of recess 40 within nut 38, to which would mate a female ratchet wrench element of wrench head 50 within surface 54. See FIGS. 6 and 9.

It is to be understood that said adapter 32 also may be integrated into said handle 20 of spherical element 12 to form a novel ball valve or the like without need for use of the adapter as a separate production item.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. In a valve for placement within a fluid conduit, the valve having a generally spherical element in fluid-tight relation to an interior diameter of said valve, a fluid flow existing through a diametric bore of said element, the element having a integral rigid handle projecting through and slightly past a proximal slot in an outer housing of said valve, an extent of fluid flow through said valve changeable by rotation of the valve handle and therewith the spherical element, an adapter comprising:
a solid body having a longitudinal axis, an inner axial base thereof complemental with said projecting valve handle of said spherical element and, at an opposite base thereof, an outer surface engagable by a complemental extension of a ratchet wrench, wherein said ratchet wrench may effect a full or partial opening or closure of said valve bore by respective incremental reciprocations, either forwardly or backwardly, of said projecting handle of said spherical element.

2. The adapter as recited in claim 1, in which said outer radial surface of said solid body defines a polygonal male structure complemental to a female engaging surface of the ratchet wrench.

3. The adapter as recited in claim 1, in which said outer radial surface of said solid body defines a female structure complemental to a male engaging surface of the ratchet wrench.

4. The adapter as recited in claim 1, in which said solid body further comprises:
an axial peripheral extension complementally engagable with an outermost assembly about said integral projecting handle of said spherical element.

5. The adapter as recited in claim 1, further comprising:
a pair of substantially radial extensions integrally projecting from an outermost periphery of said solid body, in which said extensions may be engaged by a tool to facilitate rotation of the adapter under emergency conditions in which said ratchet wrench is unavailable or inoperative.

6. In a marine, ball, butterfly, plug or cock valve or the like for placement within a fluid conduit, the valve including a spherical element in press-fit relation to an inner diameter of said valve, a valve housing, and a fluid port through said spherical element, said element having a rigid handle extending projecting externally of the valve through a slot in of the valve housing, in which fluid flow through the valve is changeable by turning of the externally projecting handle, an adapter comprising:
a solid generally cylindrical body having an axis corresponding to an axis of said integral projecting handle handle and, at an inner radial base thereof, a female recess complemental to said integral externally projecting handle of said valve and, at an opposite base thereof, an integral surface including at least a female recess complementally engagable by a male surface of a ratchet wrench,
wherein said ratchet wrench may effect a full or partial opening or closure of said valve by incremental reciprocations, either forwardly or backwardly, of said projecting handle without need for permanent attachment of the wrench to said external handle of the spherical element or to the valve.

7. The adapter as recited in claim 6, including said opposite base of said adapter surrounded by polygonal structure engagable by a female surface of the ratchet wrench.

8. The adapter as recited in claim 6, in which said solid body further comprises:
an axial peripheral extension complementally engagable with an outermost assembly about said integral projecting handle of said spherical element.

9. The adapter as recited in claim 8, further comprising:
a pair of substantially radial extensions integrally projecting from an outermost periphery of said solid body, in which said extensions may be engaged by a tool to facilitate rotation of the adapter under emergency conditions in which said ratchet wrench is unavailable or inoperative.
